(19) United States
(12) Patent Application Publication
(10) Pub. No.: US 2008/0137647 A1
(43) Pub. Date: Jun. 12, 2008

(54) VoIP terminal and method for providing multi-call service

(76) Inventor: Jae-Hoon Han, Yongin-si (KR)

Correspondence Address: ROBERT E. BUSHNELL, 1522 K STREET NW, SUITE 300, WASHINGTON, DC, 20005-1202, US

(21) Appl. No.: 11/987,109

(22) Filed: Nov. 27, 2007

(30) Foreign Application Priority Data
Dec. 7, 2006 (KR) 10-2006-0123947

(51) Int. Cl. H04L 12/66

(52) U.S. Cl. 370/352

(57) ABSTRACT

A multi-call VoIP terminal constructed with a proxy server interworking unit, connecting the multi-call VoIP terminal to a proxy server to enable communications with an external network terminal; an Sub terminal checking unit disposed to check a physical interworking status of the multi-call VoIP terminal to an IP terminal and a communicating state of the IP terminal; and a sub terminal interworking unit converting an IP address of a packet header in order to relay a packet between the proxy server and the IP terminal when the IP terminal is determined to be in a busy state when checked by the Sub terminal checking unit. The multi-call VoIP terminal and a multi-call service method can realize packet relaying through IP address conversion without an expansion or modification to a server, so that a multi-call service can be provided to users in a simple fashion.

### CLAIM OF PRIORITY

This application makes reference to, incorporates the same herein, and claims all benefits accruing under 35 U.S.C. §119 from an application for VoIP TERMINAL AND METHOD FOR PROVIDING MULTI-CALL SERVICE earlier filed in the Korean Intellectual Property Office on 7 Dec. 2006 and there duly assigned Serial No. 2006-123947.

### BACKGROUND OF THE INVENTION

1. Field of the Invention

The present invention relates to a multi-call telephone service, and more particularly, the present invention relates to an improved VoIP terminal and an improved method for providing a multi-call telephone service.

2. Description of the Related Art

The Voice over Internet Protocol (VoIP) allows voice transmission through the Internet at a low cost. Developing VoIP services are expected to replace existing Public Switched Telephone Network (PSTN) services in the near future. The VoIP also needs standard signaling protocol in order to provide advanced services, such as mobility, universal number, multiparty conference and voice mail. Examples of the signaling protocol include the H.323 of the International Telecommunication Union-T (ITU-T) and the Session Initiation Protocol (SIP) of the Internet Engineering Task Force (IETF).

The Session Initiation Protocol (SIP) is an IETF standard protocol for initiating an interactive user session that involves multimedia elements such as video, voice, chat, gaming, and virtual reality. Like HTTP (Hypertext Transfer Protocol) or SMTP (Simple Mail Transfer Protocol), SIP works in the Application layer of the Open Systems Interconnection (OSI) communications model. The Application layer is the level responsible for ensuring that communication is possible.

The Session Initiation Protocol (SIP) is an application_layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these.

SIP invitations used to create sessions carry session descriptions which allow participants to agree on a set of compatible media types. SIP supports user mobility by proxying and redirecting requests to the user's current location. Users can register their current location. SIP is not tied to any particular conference control protocol. SIP is designed to be independent of the lower_layer transport protocol and can be extended with additional capabilities.

SIP can establish multimedia sessions or Internet telephony calls, and modify, or terminate them. The protocol can also invite participants to unicast or multicast sessions that do not necessarily involve an initiator. Because the SIP supports name mapping and redirection services, it makes it possible for users to initiate and receive communications and services from any location, and for networks to identify the users where ever they are. SIP is a request_response protocol, dealing with requests from clients and responses from servers. Participants are identified by SIP URLs (Universal Resource Locators) and/or SIP URIs (Universal Resource Identifiers). Requests can be sent through any transport protocol, such as UDP (User Datagram Protocol), SCTP (Stream Control Transmission Protocol), or TCP (Transmission Control Protocol). SIP determines the end system to be used for the session, the communication media and media parameters, and the called party's desire to engage in the communication. Once these are assured, SIP establishes call parameters at either end of the communication, and handles call transfer and termination.

The SIP used when generating, modifying, and completing multimedia sessions or calls between more than one terminal on an Internet protocol_based network is an application layer control protocol, and such sessions include multimedia conference, Internet telephone call, remote education, etc.

The SIP has been modeled on the basis of SMTP, e_mail, HTTP, and the web, among others. The SIP can be called a client_server protocol for sending a response by a server when a client sends a request message.

A VoIP network uses the SIP including a User Agent (UA), a network server and a location server. In general, the UA can act as a User Agent Client (UAC) that initializes an SIP request and as a User Agent Server (UAS) that receives and replies to the SIP request.

The location server registers the present location of a user and updates the location of the user in response to his or her movement. The establishment of such VoIP networks makes it possible to provide users with a basic voice telephony service through the Internet.

These days, due to active establishment of VoIP networks, users request a multi-call service in order to use two or more phones with one ID. The multi-call service is necessary in the case where a plurality of terminals share one ID. As an instance, when a call is received, a plurality of terminals shares one ID ring at the same time, and a user selects one terminal to reply to the call. This kind of service is called a multi-call service or a phone bridge mode. This multi-call service is a very useful function at home or office. At present, however, standard SIP proxy servers do not additionally provide a multi-call service.

When the SIP proxy server receives the register request from the second SIP terminal, the SIP proxy server deletes the register information of the first SIP terminal and registers the second SIP terminal. Or, the SIP proxy server rejects the register request from the second SIP terminal. Accordingly, most of present SIP proxy servers do not support a function of managing two IDs at the same time.

Of course, the SIP proxy server can be equipped with a module for processing two IDs at the same time in order to provide the multi-call service. In order to actually process two IDs, however, the SIP proxy server should support several complicated functions such as Real Time Protocol (RTP) media connection. This necessarily makes the price of the SIP proxy server very expensive. Therefore, another, and lower cost solution should be found in order to provide multi-call service to homes or offices.

### SUMMARY OF THE INVENTION

It is therefore, one object of the present invention to provide an improved VoIP terminal and an improved method for providing multi-call telephone service.

The present invention has been made to solve the foregoing problems with the prior art and it is therefore an object of the present invention to provide a VoIP terminal and a method for providing a multi-call service by implementing a packet relaying function so that the multi-call service can be realized by two (2) SIP terminals without a modification to a typical SIP proxy server.

According to an aspect of the invention for realizing the above objects, embodiments of the invention provide a VoIP network including a proxy server; an IP terminal functioning as an SIP user agent, wherein the IP terminal provides a VoIP telecommunication service according to a predetermined protocol; and a multi-call VoIP terminal that registers and manages the IP terminal, wherein the multi-call VoIP terminal, upon receiving a VoIP service packet, processes the packet or relays the packet to the registered IP terminal according a communication state of the IP terminal.

Preferably, the multi-call VoIP terminal may be constructed with an Sub terminal checking unit that checks an interworking status and the data communication with the IP terminal; a sub terminal interworking unit that converts an IP address of a packet header in order to relay a packet between the proxy server and the IP terminal if the IP terminal is busy when checked by the Sub terminal checking unit. In the case of bypassing the packet from the proxy server to the IP terminal, the sub terminal interworking unit coverts the IP address by converting a destination field value of the packet header (the destination field value includes an address value of the multi-call VoIP terminal) into an IP address of the IP terminal. In the case of bypassing the packet from the IP terminal to the proxy server, the sub terminal interworking unit converts the IP address by converting a source field of the packet header (the field source includes an IP address value of the IP terminal) into an address of the multi-call VoIP terminal.

Preferably, the multi-call VoIP terminal further includes a message processor that processes the packet if the IP terminal is not busy when checked by the Sub terminal checking unit. The multi-call VoIP terminal manages the IP terminal by allocating an ID to the IP terminal, wherein the ID is equal to that allowed to the multi-call VoIP by the proxy server.

According to an aspect of the invention for realizing the above objects, embodiments of the invention provide a VoIP terminal including a proxy server interworking unit, which connects the multi-call VoIP terminal to a proxy server to communicate with an external network terminal; an Sub terminal checking unit that checks the physical interworking status of the multi-call VoIP terminal to an IP terminal and a state of communication of the IP terminal; and a sub terminal interworking unit that converts an IP address of a packet header in order to relay a packet between the proxy server and the IP terminal if the IP terminal is busy when checked by the Sub terminal checking unit.

Preferably, in a case of relaying the packet from the proxy server to the IP terminal, the sub terminal interworking unit coverts the IP address by converting a destination field value of the packet header (the destination field value includes an address value of the multi-call VoIP terminal) into an IP address of the IP terminal. In a case of relaying the packet from the IP terminal to the proxy server, the sub terminal interworking unit converts the IP address by converting a source field of the packet header (the source field includes an IP address value of the IP terminal) into an address of the multi-call VoIP terminal.

In this case, the multi-call VoIP terminal further includes a terminal status manager that manages a status of the multi-call VoIP terminal and a status of the IP terminal in order to prevent a contention between the multi-call VoIP terminal and the IP terminal.

According to an aspect of the invention for realizing the above objects, the invention provides a method of providing a multi-call service in a VoIP network. The method may include the steps of registering at an IP terminal in a multi-call VoIP terminal at the multi-call VoIP terminal, receiving a packet from the IP terminal or a proxy server; and at the multi-call VoIP terminal, if the IP terminal is busy, converting an IP address of the packet received to relay the packet between the IP terminal and the proxy server.

Preferably, in a case of relaying the packet from the proxy server to the IP terminal, the step of converting an IP address of the received packet converts a destination field value of a packet header (the destination field includes an address value of the multi-call VoIP terminal) into an IP address of the IP terminal. In a case of relaying the packet from the IP terminal to the proxy server, the step of converting an IP address of the received packet includes converting a source field of a packet header (the source field includes an IP address value of the IP terminal) into an address of the multi-call VoIP terminal.

Preferably, the step of registering in the multi-call VoIP terminal includes transmitting a register at the IP terminal to the multi-call VoIP terminal; and at the multi-call VoIP terminal, allocating an ID to the IP terminal, wherein the ID is equal to that allowed to the multi-call VoIP terminal by the proxy server.

The method further includes performing a VoIP telecommunication via the proxy server by processing the packet by itself at the multi-call VoIP terminal if the IP terminal is not busy.

According to an aspect of the invention for realizing the above objects, the embodiments of the invention provide a method of providing a multi-call service in a VoIP network. The method includes registering in a multi-call VoIP terminal at an IP terminal; receiving an invite message from an external network terminal at the multi-call VoIP terminal; and at the multi-call VoIP terminal, carrying out the procedure processed by general VoIP terminal receiving invite message set forth in the invite message, or converting an IP address of a header of the invite message and delivering the invite message to the IP terminal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating the architecture of a general VoIP network configured to use SIP protocol;

FIG. 2 is a schematic view illustrating problems that may occur while occurring in the event of providing a multi-call service using a general VoIP network;

FIG. 3 is a block diagram illustrating the architecture of a VoIP network for providing a multi-call service according to an exemplary embodiment of the invention;

FIG. 4 is a block diagram illustrating the internal structure of a multi-call SIP terminal;

FIG. 5 is a flowchart illustrating a process of providing a multi-call service in a multi-call SIP terminal according to another embodiment of the present invention;

FIG. 6 is a process diagram illustrating a process of relaying an invite message from a standard SIP terminal to an external terminal according to a further embodiment of the invention;

FIG. 7 illustrates an invite message that the sub terminal uses for a telecommunication with the external network terminal;

FIG. 8 illustrates a “200 OK” message that the external network terminal transmits to the sub terminal; and

FIG. 9 is a process diagram illustrating the processing of an invite message, which is received from the external terminal, according to a yet another embodiment of the present invention.

### DETAILED DESCRIPTION OF THE INVENTION

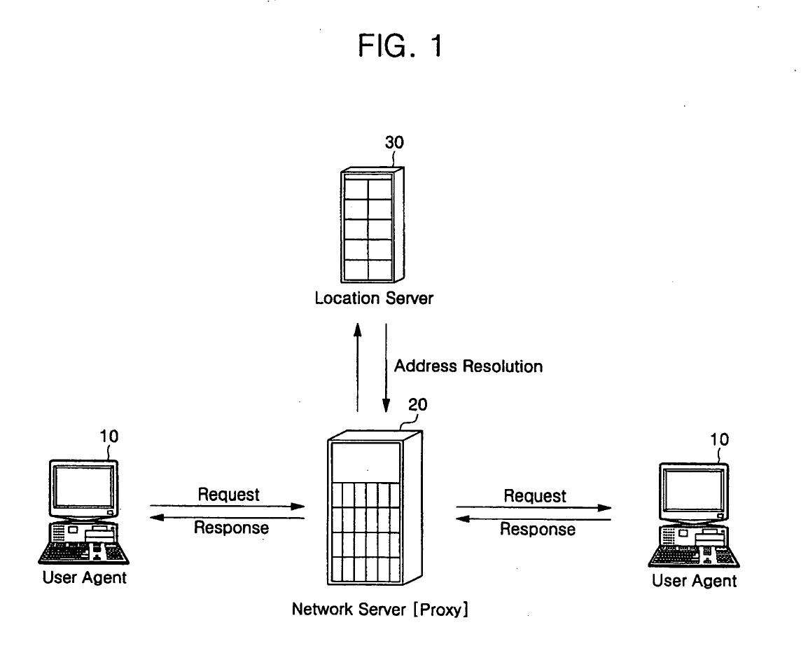

Turning now to the drawings, FIG. 1 is a schematic view illustrating the architecture of a general VoIP network using the Session Initiation Protocol (SIP).

As shown in FIG. 1, a VoIP network using the SIP includes User Agent (UA) 10, network server 20 and location server 30.

In general, UA 10 can act as a User Agent Client (UAC) that initializes an SIP request and as a User Agent Server (UAS) that receives and replies to the SIP request.

The network server 20 can be a proxy server or a redirection server according to the delivery scheme of the SIP request. Although a multi-call service illustrated herein uses the proxy server, it should be understood that the scope of the present invention embraces the use of the redirection server.

The location server 30 registers the present location of a user and updates the location of the user in response to his/her movement. The establishment of such VoIP networks makes it possible to provide users with a basic voice telephony service through the Internet.

These days, due to active establishment of VoIP networks, users request a multi-call service in order to use two or more phones with one ID. The multi-call service is necessary in the case where a plurality of terminals share one ID. As an instance, when a call is received, a plurality of terminals sharing one ID ring at the same time, and a user selects one terminal to reply to the call. This kind of service is called a multi-call service or a phone bridge mode. This multi-call service is a very useful function at home or office. At present, however, standard SIP proxy servers do not additionally provide a multi-call service.

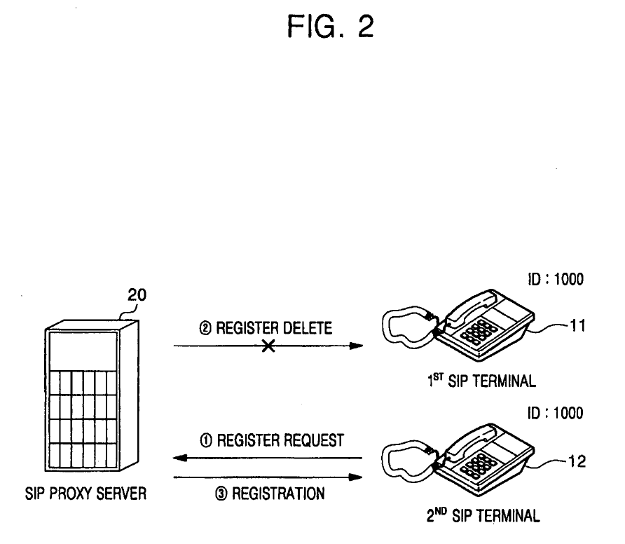

FIG. 2 is a schematic view illustrating problems occurring in the event of providing a multi-call service using a general VoIP network.

As shown in FIG. 2, the VoIP network includes two SIP terminals 11 and 12, which share one ID, and SIP proxy server 20 in order to provide a multi-call service.

For the multi-call service, the two SIP terminals 11 and 12 should be allocated with the same ID. The schematic view of FIG. 2 illustrates registration procedures in which the first and second SIP terminals register in the proxy server, using the same ID “1000.”

For example, it will be assumed that first SIP terminal 11 is registered in SIP proxy server 20 using the ID “1000.” In order to provide a multi-call service, second SIP terminal 12 must send a register request to the proxy server using the ID “1000.”

When SIP proxy server 20 receives the register request from second SIP terminal 12, SIP proxy server 20 deletes the register information of first SIP terminal 11, which is connected thereto with the ID “1000,” and registers second SIP terminal 12. Alternatively, SIP proxy server 20 rejects the register request from second SIP terminal 12. Accordingly, most of present SIP proxy servers do not support a function of managing two IDs at the same time.

Of course, the SIP proxy server can be equipped with a module for processing two IDs at the same time in order to provide the multi-call service. In order to actually process two IDs, however, it is critical that SIP proxy server 20 should support several complicated functions such as a Real Time Protocol (RTP) media connection, thereby causing the price of the SIP proxy server to become very expensive. Consequently, a solution which necessitates equipping the SIP proxy server with a deal time protocol media connection is not a viable technique for providing multi-call service to homes or offices.

A VoIP terminal and a method for providing a multi-call service according to the present invention will now be described more fully hereinafter with reference to the accompanying drawings, in which preferred embodiments thereof are shown.

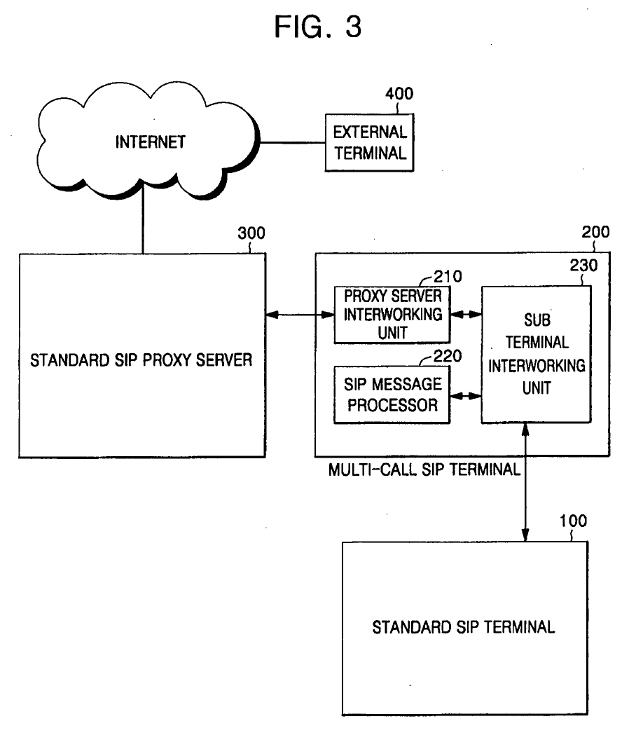

FIG. 3 is a block diagram illustrating the architecture of a VoIP network for providing a multi-call service according to an exemplary embodiment of the invention. The VoIP network includes a standard SIP terminal 100, a SIP terminal 200 for providing a multi-call (hereinafter also referred to as “multi-call SIP terminal”) and a standard SIP proxy server 300.

Standard SIP proxy server 300 corresponds to a commercially available server that conducts the registration of SIP user agent terminals and session control. Standard SIP proxy server 300 is well-known in the art, and examples thereof include OfficeServ 7200, Ondo SIP server and other models, available from Samsung Electronics Co. Ltd. Accordingly, additional detailed description of the SIP proxy server will not be necessary.

Standard SIP terminal 100 performs an SIP user agent function, and provides SIP based functions, such as session connection and media data transmission/reception, to a user. In the embodiments of the present invention, the standard SIP terminal acts as a sub terminal. Hereinafter, the standard SIP terminal will also be referred to as “sub terminal.” Herein, detailed description of the internal structure of standard SIP terminal 100 will be omitted since a conventional SIP terminal can be used in the practice of the principles of the present invention.

A multi-call SIP terminal 200 is devised according to the key technical concept of the present invention. The functionality of multi-call terminal 200 is to cooperate with standard SIP terminal 100 and standard SIP proxy server 300 to provide multi-call service to the users.

Multi-call SIP terminal 200 acts as a main terminal whereas standard SIP terminal 100 acts as a sub terminal. Hereinafter, the multi-call SIP terminal will also be referred to as “main terminal.” That is, multi-call SIP terminal 200 receives a packet from standard SIP proxy server 300, and processes the packet by itself or bypasses the packet to standard SIP terminal 100. That is, while standard SIP terminal 100 only processes the received packet, the multi-call SIP terminal 200 determines a terminal that shall process the packet.

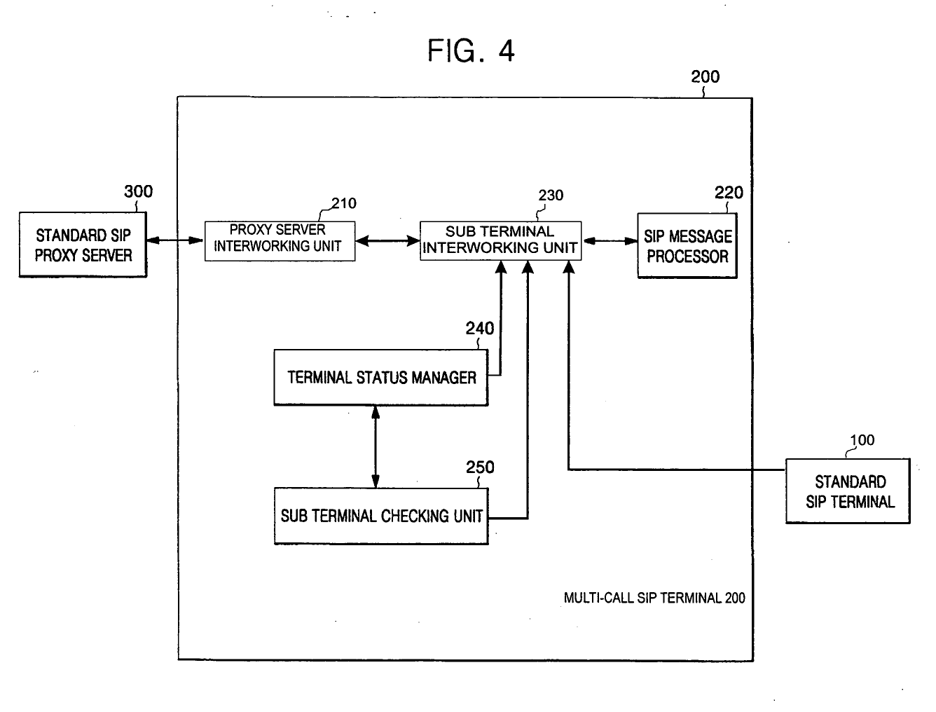

FIG. 4 is a block diagram illustrating the internal structure of a multi-call SIP terminal. Multi-call SIP terminal 200 has a proxy server interworking unit 210, an SIP message processor 220, a sub terminal interworking unit 230, a terminal status manager 240 and a sub terminal checking unit 250.

Proxy server interworking unit 210 is a component that interworks multi-call SIP terminal 200 with standard proxy server 300 in order to perform server interworking functions such as registration and link holding of the multi-call SIP terminal. Since standard SIP terminal 100 is connected only to multi-call SIP terminal 200, standard SIP proxy server 300 registers only multi-call SIP terminal 200.

SIP message processor 220 is a component that processes SIP sessions and SIP messages. Herein, it is assumed that two SIP sessions are created. The first one is the SIP session between the standard SIP proxy server 300 and the multi-call SIP terminal 200, and the second one is the SIP session between multi-call SIP terminal 200 and standard SIP terminal 100. SIP message processor 220 also processes an SIP message which is necessary for establishing the two SIP sessions above.

Sub terminal checking unit 250 checks an interworking status of standard SIP terminal 100 (i.e., sub terminal), and checks whether or not data transmission/reception to/from standard SIP terminal 100 is being carried. If an interworking mode of standard SIP terminal 100 is not set, packets are processed only by SIP message processor 220.

Sub terminal interworking unit 230 is a component which determines whether a received packet will be processed in multi-call SIP terminal 200 (i.e., main terminal) or in sub terminal 100, and forwards the packet according to the result. The details if the functionality of sub terminal interworking unit 230 will be described in the description of packet transmission and packet reception.

First, a case wherein standard SIP terminal 100 should transmit a packet to external terminal 400 via standard proxy server 300 is discussed as follows. Sub terminal interworking unit 230 relays a packet delivered from standard SIP terminal 100 to SIP proxy server 300. First, sub terminal interworking unit 230 checks the communicating state of standard SIP terminal 100. For example, if multi-call SIP terminal 200 is busy, standard SIP terminal 100 cannot have a telecommunication. Then, an invite cancel message, which informs rejection to packet processing, is transmitted to standard SIP terminal 100.

In this case, the sub terminal interworking unit 200 converts the source IP address field value of an SIP packet header, wherein the SIP packet is transmitted from sub terminal 100, into the IP address of main terminal 200. After the conversion of the IP address as above, the SIP packet is delivered to standard SIP proxy server 300 via proxy server interworking unit 210.

Second, a case wherein multi-call SIP terminal 200 relays a packet to standard SIP terminal 100 will be discussed. Sub terminal interworking unit 230 judges whether the sub terminal interworking unit itself processes the received packet or relays the packet to standard SIP terminal This judgment is made by checking the communicating state of multi-call SIP terminal 200 and standard SIP terminal 100.

When the packet received from standard SIP proxy server 300 is supposed to be processed by main terminal 200, sub terminal interworking unit 230 delivers the packet to SIP message processor 220. On the contrary, when the received packet is supposed to be processed by standard SIP terminal 100, the packet is relayed to standard SIP terminal 100.

In this case, sub terminal interworking unit 230 analyzes the SIP header of the packet, wherein the packet is transmitted from standard proxy server 300. The destination address of this SIP header is supposed to have an IP address value of multi-call SIP terminal 200 (i.e., the main terminal). Sub terminal interworking unit 230 converts the destination address of the SIP header to the IP address of the standard SIP terminal 100 (i.e., the sub terminal). After the IP address is converted, the packet can be delivered to the sub terminal.

When both of multi-call SIP terminal 200 and standard SIP terminal 100 are idle, an invite message can be received from external terminal 400. In this case, sub terminal interworking unit 230 can ring in response to the received invite message, or relay the invite message to standard SIP terminal 100 by converting the IP address of the invite message. A busy state refers to a not-idle state and a not-busy states refers to an idle state.

Terminal status manager 240 manages the status of the telecommunication between multi-call SIP terminal 200 and standard SIP terminal 100. Through such management of the telecommunication status, terminal status manager 240 can prevent contention.

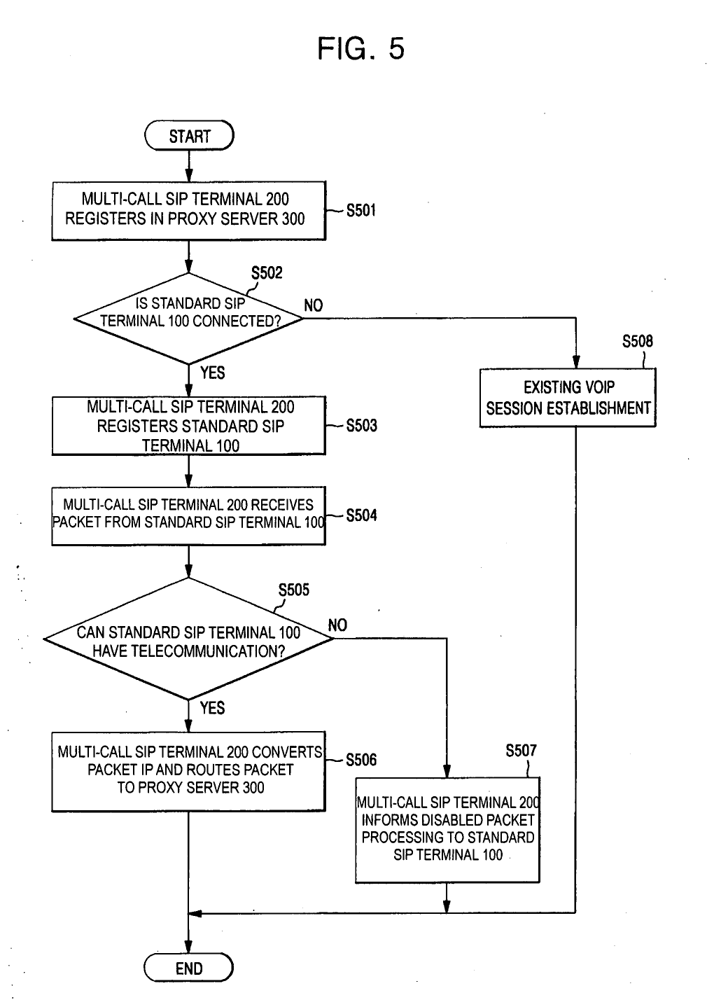

FIG. 5 is a flowchart illustrating a process of providing a multi-call service in a multi-call SIP terminal according to another embodiment of the present invention. First, multi-call SIP terminal 200 (i.e., the main terminal) registers in standard SIP proxy server 300 in step S501. Multi-call SIP terminal 200 checks whether or not SIP terminal 100 (i.e., the sub terminal) is physically connected to multiple-call SIP terminal 200 in step S502. If standard SIP terminal 100 is not connected, multi-call SIP terminal 200 carries out the procedure processed by general VoIP terminal receiving invite message for VoIP telecommunication according to standard SIP in S508.

If standard SIP terminal 100 is physically connected to multi-call SIP terminal 200, multi-call SIP terminal 200 registers standard SIP sub terminal 100 therein in step S503. In this case, standard SIP terminal 100 carries out registration procedures by regarding multi-call SIP terminal 200 as standard SIP proxy server 300. In the present invention, since multi-call SIP terminal 200 and standard SIP terminal 100 use the same ID, multi-call SIP terminal 200 allocates ID and password, which are allowed by standard SIP proxy server 300, to standard SIP terminal 100.

In step S504, multi-call SIP terminal 200 receives an SIP packet, which is necessary for the telecommunication with the external terminal, from standard SIP terminal 100. In step S505, multi-call SIP terminal 200 checks the communicating state of standard SIP terminal 100 to see whether or not standard SIP terminal 100 can have a telecommunication.

Here, the main factor for determining the communicating state of standard SIP terminal 100 is whether or not multi-call SIP terminal 200 is busy at present. In the present invention, since the main terminal and the sub terminal share the same ID, it could be impossible that both the terminals conduct a telecommunication at the same time. Accordingly, if the main terminal is already carrying out a telecommunication with a third party, the sub terminal cannot carry out another telecommunication.

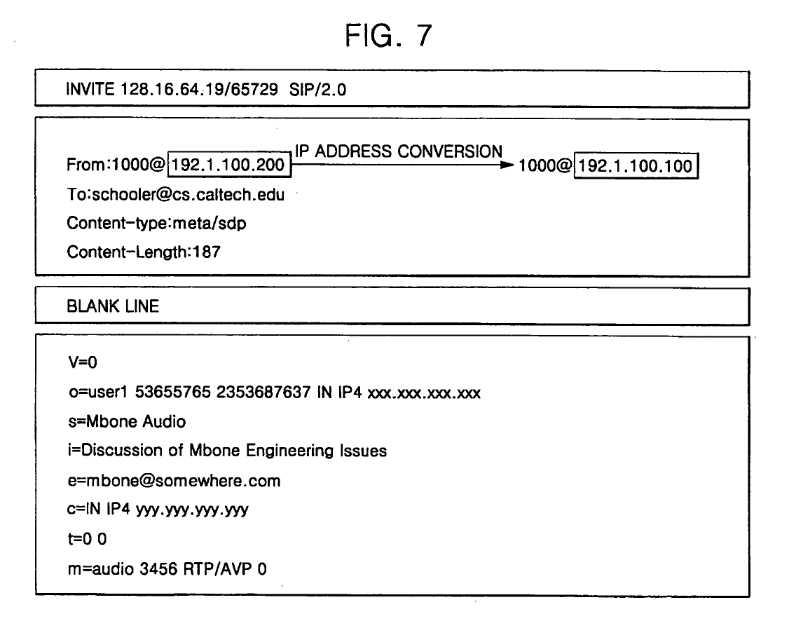

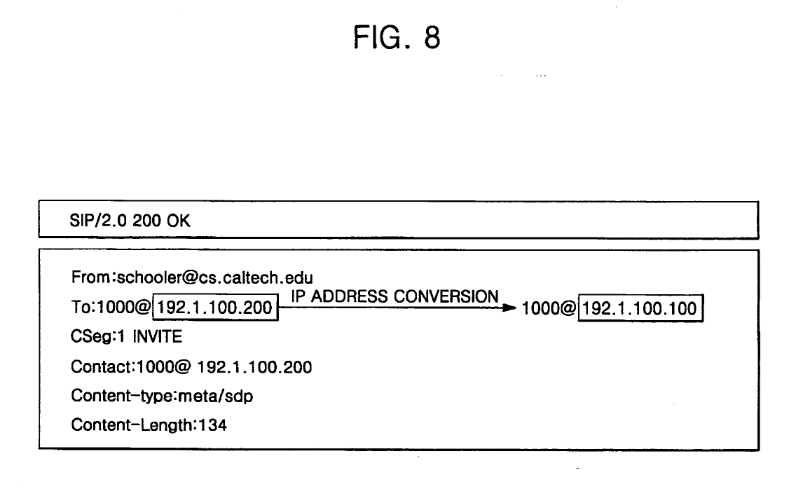

If standard SIP terminal 100 is enabled to have a telecommunication, multi-call SIP terminal 200 converts the IP address of the packet, wherein the packet is received from the standard SIP terminal, and forwards the packet toward standard SIP proxy server 300 in step S506. The procedures of IP address conversion will be described in more details with reference to FIG. 7 and FIG. 8. If it is checked that the standard SIP terminal cannot have a telecommunication in step S505, the multi-call SIP terminal transmits an invite cancel message to the standard SIP terminal informing that the packet cannot be processed in step S507.

As stated above, it has been described of the method for providing a multi-call service, by which the standard SIP terminal transmits a packet to the external terminal. In FIG. 4 and FIG. 5, a process of relaying a packed receiving from the external terminal to the standard SIP terminal has been described.

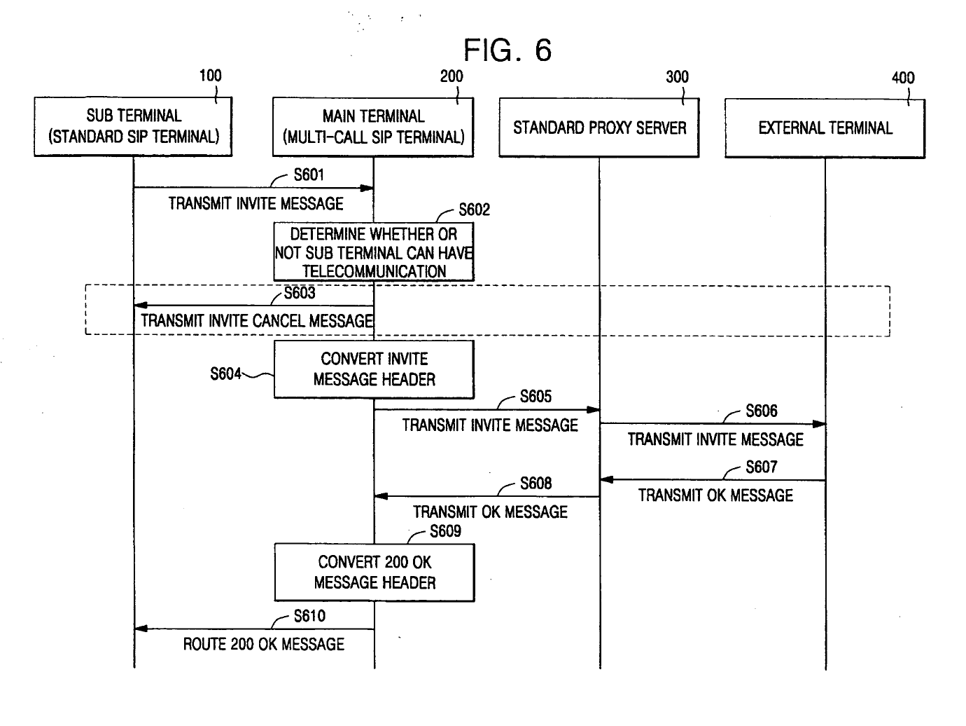

FIG. 6 is a process diagram illustrating a process of relaying an invite message from a standard SIP terminal to an external terminal according to a further embodiment of the invention. The operation of the multi-call SIP terminal or the main terminal has been described FIG. 5. In FIG. 6, it will be described of the case where a message is transmitted and/or received in the session processing between a standard SIP terminal and an external network terminal.

In step S601, after the registration of standard SIP terminal 100, standard SIP terminal 100 transmits an invite message to multi-call SIP terminal 200 as an attempt to call external network terminal 400 (hereinafter also referred to as “external terminal”). A “From” field of the invite message includes an IP address value of standard SIP terminal 100, and a “To” field of the invite message includes an IP address value of external terminal 400.

In step S602, when multi-call SIP terminal 200 receives the invite message, it checks the communicating state of the sub terminal. If the telecommunication of the sub terminal is impossible, multi-call terminal 200 transmits an invite cancel message to the sub terminal informing that the telecommunication cannot be enabled in S603.

If the telecommunication of the sub terminal can be enabled, multi-call terminal 200 in step S604 converts the header of the invited message received in step S601, and delivers the header-converted invite message to the standard proxy server in step S605.

After standard SIP proxy server 300 receives the invite message from main terminal 200, it transmits the invite message to external terminal 400 using a location server (not shown) and the like in step S606. When external terminal 400 receives the invite message, it transmits a “200 OK” message to SIP proxy server 300 to inform the receipt of the invite message in step S607.

In step S608, standard SIP proxy server 300 routes the “200 OK” message to main terminal 200. A “To” field of the header of the “200 OK” message, in step S608, includes the address value of main terminal 200. In step S609, main terminal 200 converts the value of the “To” field into the address of sub terminal 100 in order to transmit the “200 OK” message to sub terminal 100. In S610, main terminal 200 converts the IP address of the header and routes the “200 OK” message to sub terminal 100.

As explained above, the SIP session between standard SIP terminal 100 and external terminal 400 is set through the procedures S604 to S610. After the SIP session is set, transmission/reception of RTP media data is started and performed in a similar process.

FIG. 7 illustrates an invite message that the sub terminal uses for a telecommunication with the external network terminal. The invite message shown in FIG. 7 corresponds to the invite message used in the session setting procedure in FIG. 6. In FIG. 7, it is assumed that the private IP address of multi-call SIP terminal 200 is 192.1.100.100, and the IP address of standard SIP terminal 100 (i.e., the sub terminal) is 192.1.100.200. In addition, the ID of external terminal 400 is assumed to be schooler@cs.caltech.edu.

A “From” field of the invite message shown in FIG. 7 corresponds to the IP address of a source terminal, and thus has the IP address of the sub terminal which is 192.1.100.200. Also, a “To” field of the invite message includes address information of a receiving terminal, and thus has the ID of external terminal 400 which is schooler@cs.caltech.edu.

Multi-call SIP terminal 200 receives an invite message from standard SIP terminal 100. Then, multi-call SIP terminal 200 converts the IP address of the “From” field into its own IP address 192.1.100.100 and routes the invite message to SIP proxy server 300.

FIG. 8 illustrates a “200 OK” message that the external network terminal transmits to the sub terminal. Likewise, it is assumed that the private IP address of multi-call SIP terminal 200 is 192.1.100.100 and the IP address of standard SIP terminal 100 is 192.1.100.200. The ID of external terminal 400 is assumed to be schooler@cs.caltech.edu.

Standard SIP proxy server 300 judges the invite message, received in procedure S605, as that transmitted from main terminal 200. Hence, standard SIP proxy server 300 transmits the “200 OK” message, received from external terminal 400, to main terminal 200. For this purpose, a “To” field value of the “200 OK” message shown in FIG. 8 has the address of the multi-call SIP terminal which is 192.1.100.100.

Multi-call SIP terminal 200, upon receiving the “200 OK” message, has to forward the “200 OK” message to standard SIP terminal 100. For this purpose, main terminal 200 converts the value of the “To” field to the address of the sub terminal 192.1.100.200, and after the address conversion, routes the “200 OK” message to sub terminal 100.

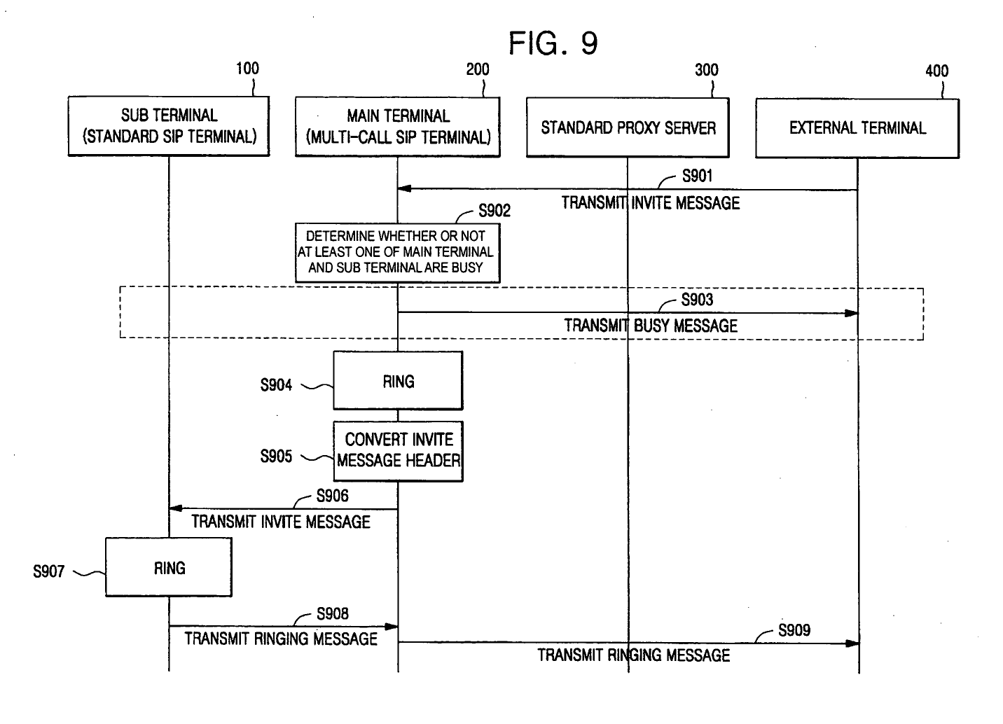

FIG. 9 is a process diagram illustrating the processing of an invite message, which is received from the external terminal, according to a yet another embodiment of the present invention. In this embodiment as shown in FIG. 9, it is assumed that standard SIP terminal 100 has been successfully registered as in the embodiment as shown in FIG. 6. In step S901, multi-call SIP terminal 200 receives an invite message from external terminal 400 through standard SIP proxy server 300. Since only multi-call SIP terminal 200 is registered in the standard SIP proxy server, a “To” field of the invite message in S901 includes an IP address value of the multi-call SIP terminal 200.

In step S902, multi-call SIP terminal 200 determines whether or not at least one of the communicating state of multi-call SIP terminal 200 (i.e., main terminal) and standard SIP terminal 100 (i.e., sub terminal) is busy. If multi-call SIP terminal 200 or standard SIP terminal 100 is busy, multi-call SIP terminal 200 sends back a busy message external terminal 400 via standard SIP proxy server 300 in step S903. If no terminals are determined to be busy in the procedure S902, the multi-call SIP terminal rings to inform a user of a phone call in step S904. In step S905, the multi-call SIP terminal converts the IP address of the invite message, received in the procedure S901. Subsequently, in step S906, the multi-call SIP terminal 200 relays the invite message to standard SIP terminal 100.

When standard SIP terminal 100 receives the invite message from multi-call SIP terminal 200, standard SIP terminal 100 rings in step S907, and sends a ringing message, informing that it is ringing, to multi-call SIP message 200 in step S908. When multi-call SIP terminal 200 receives the ringing message from standard SIP terminal 100, it routes the ringing message to the external terminal via standard SIP proxy server 300 in step S909.

According to the present invention as set forth above, the multi-call VoIP terminal and the method can realize packet relaying through IP address conversion without an expansion or modification to a server, so that a multi-call service can be provided to users in a simple fashion. Furthermore, since the multi-call VoIP terminal of the invention can interwork with standard VoIP terminals, it is possible to simply provide the multi-call service using existing VoIP terminals.

While the present invention has been shown and described in connection with the preferred embodiments, it will be apparent to those skilled in the art that modifications and variations can be made without departing from the spirit and scope of the invention as defined by the appended claims.

What is claimed is:

1. A Voice over Internet Protocol (VoIP) network, comprising:
a proxy server;
an Internet Protocol (IP) terminal functioning as a Session Initiation Protocol (SIP) user agent and providing a VoIP telecommunication service according to a predetermined protocol; and
a multi-call VoIP terminal registering and managing said IP terminal, wherein said multi-call VoIP terminal, upon receiving a VoIP service packet, selectively processes the packet and relays the packet to said registered IP terminal according a state of communication by said IP terminal.

2. The VoIP network according to claim 1, with said multi-call VoIP terminal comprising:
an Sub terminal checking unit checking a physical interworking status and a data communication state of said IP terminal; and
a sub terminal interworking unit converting an IP address of a packet header in order to relay a packet between said proxy server and said IP terminal when said IP terminal is busy when checked by said Sub terminal checking unit.

3. The VoIP network according to claim 2, with said sub terminal interworking unit converting the IP address by converting a destination field value of the packet header, which includes an address value of said multi-call VoIP terminal, into an IP address of said IP terminal, in a case of bypassing the packet from said proxy server to said IP terminal.

4. The VoIP network according to claim 2, with said sub terminal interworking unit converting the IP address by converting a source field of the packet header said source field comprising an IP address value of said IP terminal, into an address of said multi-call VoIP terminal, when bypassing the packet from said IP terminal to said proxy server.

5. The VoIP network according to claim 2, with said multi-call VoIP terminal further concluding a message processor processing the packet when said IP terminal is not busy when checked by said Sub terminal checking unit.

6. The VoIP network according to claim 1, with said multi-call VoIP terminal managing said IP terminal by allocating an ID same as the ID to said IP terminal, wherein the ID is equal to the ID of said multi-call VoIP terminal and is allowed by said proxy server.

7. A multi-call Voice over Internet Protocol (VoIP) terminal, comprising:
a proxy server interworking unit connects said multi-call VoIP terminal to a proxy server to communicate with an external network terminal;
an Sub terminal checking unit disposed to check a physical interworking status of said multi-call VoIP terminal to an Internet Protocol (IP) terminal and a data communication state of the IP terminal; and
a sub terminal interworking unit disposed to convert an IP address of a packet header in order to relay a packet between the proxy server and the IP terminal when said IP terminal is busy when checked by said Sub terminal checking unit.

8. The multi-call VoIP terminal according to claim 7, with said sub terminal interworking unit converting the IP address by converting a destination field value of the packet header, said destination field including an address value of said multi-call VoIP terminal, into an IP address of the IP terminal when relaying the packet from the proxy server to the IP terminal.

9. The multi-call VoIP terminal according to claim 7, with said sub terminal interworking unit converting the IP address by converting a source field of the packet header said source field including an IP address value of the IP terminal, into an address of said multi-call VoIP terminal when relaying the packet from the IP terminal to the proxy server.

10. The multi-call VoIP terminal according to claim 7, further comprising a terminal status manager disposed to manage status of said multi-call VoIP terminal and a status of the IP terminal in order to prevent a contention between the multi-call VoIP terminal and the IP terminal.

11. A method of providing a multi-call service in a Voice over Internet Protocol (VoIP) network, comprising:
at an Internet Protocol (IP) terminal registering in a multi-call VoIP terminal;
at the multi-call VoIP terminal, receiving a packet from one of the IP terminal and a proxy server; and
at the multi-call VoIP terminal when the IP terminal is busy, converting an IP address of the received packet to relay the packet between the IP terminal and the proxy server.

12. The method according to claim 11, with said step of converting an IP address of the received packet comprising converting a destination field value of a packet header, said destination field value comprising an address value of the multi-call VoIP terminal, into an IP address of the IP terminal when relaying the packet from the proxy server to the IP terminal.

13. The method according to claim 11, with said step of converting an IP address of the received packet comprised of converting a source field of a packet header, said source field including an IP address value of the IP terminal, into an address of said multi-call VoIP terminal when relaying the packet from the IP terminal to the proxy server.

14. The method according to claim 11, wherein said step of registering in the multi-call VoIP terminal comprises:
at the IP terminal, transmitting a register message to the multi-call VoIP terminal; and
at the multi-call VoIP terminal, allocating an ID to the IP terminal, wherein the ID is equal to the ID of said multi-call VoIP terminal and is allowed by the proxy server.

15. The method according to claim 11, further comprising:
at the multi-call VoIP terminal, individually processing the packet to perform a VoIP telecommunication via the proxy server when the IP terminal is not busy.

16. A method of providing a multi-call service in a Voice over Internet Protocol (VoIP) network, comprising:
at an Internet Protocol (IP) terminal registering in a multi-call VoIP terminal;
at the multi-call VoIP terminal, receiving an invite message from an external network terminal; and
at the multi-call VoIP terminal, carrying out general VoIP session establishment according to the invite message when said IP terminal is not physically connected to said multi-call VoIP terminal,
at the multi-call VoIP terminal, checking a communication state of said IP terminal when said IP terminal is physically connected to said multi-call VoIP terminal,
at the multi-call VoIP terminal, transmitting an invite cancel message to said sub terminal when the checked communication state of said IP terminal can not be enabled, converting an IP address of a header of the invite message and delivering the invite message to the IP terminal when the checked communication state of said IP terminal can be enabled.
